(19) United States
(12) Patent Application Publication
(10) Pub. No.: US 2020/0170006 A1
(43) Pub. Date: May 28, 2020

(54) METHODS AND DEVICES FOR DATA COMMUNICATION BASED ON LICENSE ASSISTED ACCESS

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 16/631,971

(22) PCT Filed: Jul. 21, 2017
(86) PCT No.: PCT/CN2017/093926

§ 371 Date: Jan. 17, 2020

(51) Int. Cl. H04W 72/04; H04L 5/00; H04W 16/14

(52) U.S. Cl. CPC H04W 72/0413; H04W 16/14; H04L 5/0094; H04W 72/0446

(57) ABSTRACT

Embodiments of the present disclosure relate to a method, terminal device and apparatus for data communication based on License Assisted Access (LAA) at a terminal device and a method, network device and apparatus for data communication based on LAA at a network device. In an embodiment of the present disclosure, the method for data communication based on LAA at a terminal device may include performing, at the terminal device, the data communication based on LAA only within part of slots of a subframe. With embodiments of the present disclosure, it is possible to share the unlicensed channel between the NR-based LAA and LTE-based LAA in a fair way and thus it may provide a good coexistence between the NR-based LAA and LTE-based LAA.

### FIELD OF THE INVENTION

The non-limiting and exemplary embodiments of the present disclosure generally relate to the field of wireless communication techniques, and more particularly relate to a method, terminal device and apparatus for data communication based on License Assisted Access (LAA) at a terminal device and a method, network device and apparatus for data communication based on LAA at a network device.

### BACKGROUND OF THE INVENTION

In order to improve the data rate performance, in the third generation Partnership Project (3GPP) Long Term Evolution (LTE), there is introduced License Assisted Access (LAA) for both downlink and uplink transmission.

In order to further improve the user's performance, a new radio access system, which is also called as NR system or NR network, has been introduced as the next generation communication system. As the LTE network enters its next phase of evolution with the study of wider bandwidth waveform under the NR project, it is natural for the LAA networks to evolve into the 5G NR system. In RAN meeting #76, a study item called “Study on NR-Based Access to Unlicensed Spectrum” had been agreed.

Regarding the LAA in the NR system, it shall study physical channels inheriting choices of duplex mode, waveform, carrier bandwidth, subcarrier spacing, frame structure, and physical layer design. It shall also study how to avoid unnecessary divergence with decisions made in the NR WI.

In addition, it shall also study physical channels inheriting choices of duplex mode, waveform, carrier bandwidth, subcarrier spacing, frame structure, and physical layer design. It shall also study how to avoid unnecessary divergence with decisions made in the NR WI.

Besides, it shall further study unlicensed bands both below and above 6 GHz, up to 52.60 Hz. Thus, it is essential to ensure that a NR-based unlicensed access wideband system operates as a “good neighbor” towards all forms of legacy systems. Moreover, due to differences between numerologies in the NR system and LTE system, it shall also consider coexistence of the two systems.

When the LTE system and the NR system coexist within the same band, in the LTE system, UE can transmit in symbol 0, 1 and 7, 8, while in the NR system, UE can transmit in LTE symbols 2, 3. This might also cause unfairness in resource utilization between the NR system and the LTE system.

Thus, there is a need for a new solution of data communication based on LAA.

### SUMMARY OF THE INVENTION

To this end, in the present disclosure, there is provided a new solution for data communication based on LAA, to mitigate or at least alleviate at least part of the issues in the prior art.

According to a first aspect of the present disclosure, there is provided a method for data communication based on LAA at a terminal device in a NR system. The method may comprise performing, at the terminal device, the data communication based on LAA only within part of slots of a subframe.

According to a second aspect of the present disclosure, there is provided a method for data communication based on LAA at a network device in a NR system. The method may comprise performing, at the network device, the data communication based on LAA only within part of slots of a subframe.

According to a third aspect of the present disclosure, there is provided a terminal device. The terminal device may comprise a transceiver, configured to perform the data communication based on LAA; and a controller, configured to control the data communication based on LAA so that the data communication based on LAA is performed only within part of slots of a subframe.

According to a fourth aspect of the present disclosure, there is provided a network device. The network device may comprise a controller, configured to perform the data communication based on LAA; and a transceiver, configured to control the data communication based on LAA so that the data communication based on LAA is performed only within part of slots of a subframe.

According to a fifth aspect of the present disclosure, there is provided a terminal device. The terminal device may comprise a processor and a memory. The memory may be coupled with the processor and have program codes therein, which, when executed on the processor, cause the terminal device to perform operations of the first aspect.

According to a sixth aspect of the present disclosure, there is provided a network device. The network device may comprise a processor and a memory. The memory may be coupled with the processor and having program codes therein, which, when executed on the processor, cause the network device to perform operations of the second aspect.

According to a seventh aspect of the present disclosure, there is provided a computer-readable storage media with computer program codes embodied thereon, the computer program codes configured to, when executed, cause an apparatus to perform actions in the method according to any embodiment in the first aspect.

According to an eighth aspect of the present disclosure, there is provided a computer-readable storage media with computer program codes embodied thereon, the computer program codes configured to, when executed, cause an apparatus to perform actions in the method according to any embodiment in the second aspect.

According to a ninth aspect of the present disclosure, there is provided a computer program product comprising a computer-readable storage media according to the seventh aspect.

According to a tenth aspect of the present disclosure, there is provided a computer program product comprising a computer-readable storage media according to the eighth aspect.

With embodiments of the present disclosure, it is possible to share the unlicensed channel between the NR-based LAA and LTE-based LAA in a relatively fair way and thus it may provide a good coexistence between the NR-based LAA and LTE-based LAA.

### BRIEF DESCRIPTION OF THE DRAWINGS

The above and other features of the present disclosure will become more apparent through detailed explanation on the embodiments as illustrated in the embodiments with reference to the accompanying drawings, throughout which like reference numbers represent same or similar components and wherein:

FIG. 1 schematically illustrates an example of data scheduling in the LTE system with a subcarrier spacing of 15 KHz.;

FIG. 2 schematically illustrates newly introduced start points in the LTE system;

FIG. 3 schematically illustrates transmission opportunities of NR-based LAA and LTE-based LAA in downlink (DL) data transmission;

FIG. 4 schematically illustrates transmission opportunities of NR-based LAA and LTE-based LAA in uplink (UL) data transmission;

FIG. 5 schematically illustrates a flow chart of a method for data communication based on LAA at a terminal device in a NR system according to an embodiment of the present disclosure;

FIG. 6 schematically illustrates example transmission opportunities of NR-based LAA and LTE-based LAA in DL data transmission according to an embodiment of the present disclosure;

FIG. 7 schematically illustrates example transmission opportunities of NR-based LAA and LTE-based LAA in UL data transmission according to an embodiment of the present disclosure;

FIG. 8 schematically illustrates another example transmission opportunities of NR-based LAA and LTE-based LAA in DL data transmission according to an embodiment of the present disclosure;

FIG. 9 schematically illustrates another example transmission opportunities of NR-based LAA and LTE-based LAA in UL data transmission according to an embodiment of the present disclosure;

FIG. 10 schematically illustrates a flow chart of a method for data communication based on LAA at a network device in a NR system according to an embodiment of the present disclosure;

FIG. 11 schematically illustrates a block diagram of an apparatus for data communication based on LAA at a terminal device in a NR system according to an embodiment of the present disclosure;

FIG. 12 schematically illustrates a block diagram of an apparatus for data communication based on LAA at a network device in a NR system according to an embodiment of the present disclosure; and

FIG. 13 schematically illustrates a simplified block diagram of an apparatus 1310 that may be embodied as or comprised in a network device like gNB, and an apparatus 1320 that may be embodied as or comprised in a terminal device like UE as described herein.

### DETAILED DESCRIPTION OF EMBODIMENTS

Hereinafter, the solution as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

Generally, all terms used in the claims are to be interpreted according to their ordinary meaning in the technical field, unless explicitly defined otherwise herein. All references to “a/an/the/said [element, device, component, means, step, etc.]” are to be interpreted openly as referring to at least one instance of said element, device, component, means, unit, step, etc., without excluding a plurality of such devices, components, means, units, steps, etc., unless explicitly stated otherwise. Besides, the indefinite article “a/an” as used herein does not exclude a plurality of such steps, units, modules, devices, and objects, and etc.

Additionally, in a context of the present disclosure, user equipment (UE) may refer to a terminal, a Mobile Terminal (MT), a subscriber station, a portable subscriber station, Mobile Station (MS), or an Access Terminal (AT), and some or all of the functions of the UE, the terminal, the MT, the SS, the portable subscriber station, the MS, or the AT may be included. Furthermore, in the context of the present disclosure, the term “BS” may represent, e.g., a node B (NodeB or NB), an evolved NodeB (eNodeB or eNB), gNB (next generation Node B), a radio header (RH), a remote radio head (RRH), a relay, or a low power node such as a femto, a pico, and so on.

For illustration purposes, description will be first made to the data scheduling of data transmission on the unlicensed band in the LTE system. As specified in section 5.3.3 of 3GPP TS 26.212.e30, Downlink Control Indication (DCI) formats 0A, 0B, 4A and 4B have been defined to schedule uplink transmission one the unlicensed band. In formats 0A/0B, 2 bits are used to indicate the starting position of physical uplink shared channel (PUSCH); in formats 4A/4B, which are designed for multi-subframe scheduling, 2 bits are used to indicate the starting position of physical uplink shared channel (PUSCH) but it can be applicable to only the first scheduled subframe. The following table illustrates relationships between the 2 bits and the PUSCH starting position.

TABLE 5.3.1.1A-1
PUSCH starting position

| Value | PUSCH starting position |
|---|---|
| 00 | symbol 0 |
| 01 | 25 μs in symbol 0 |
| 10 | (25 + TA)μs in symbol 0 |
| 11 | Symbol 1 |

From the above table, it can be seen that in the LTE system, the UL data transmission can start from any of symbol 0, 25 μs in symbol 0, (25+TA) μs in symbol 0 or Symbol 1, wherein TA denote a time advance time to be applied.

FIG. 1 illustrates an example of data scheduling in the LTE system with subcarrier spacing of 15 KHz. In FIG. 1, there are illustrated four possible starting positions corresponding to four possible values of the two bits.

In 3GPP RNA1 #89, it was already agreed to use one more starting position. According to outcome of offline discussion on UL partial subframes, UL partial subframe transmission start at symbol #7 is supported with both Mode 1 and Mode 2. In Mode 1, the UE may start a Rel-14 start point or at symbol #7, which is dependent on, for example, the outcome of Listen before Talk (LBT) operations; in Mode 2, the UL grant indicates starting position at symbol #7 and additional starting points between symbols #7 and #8 are for further study.

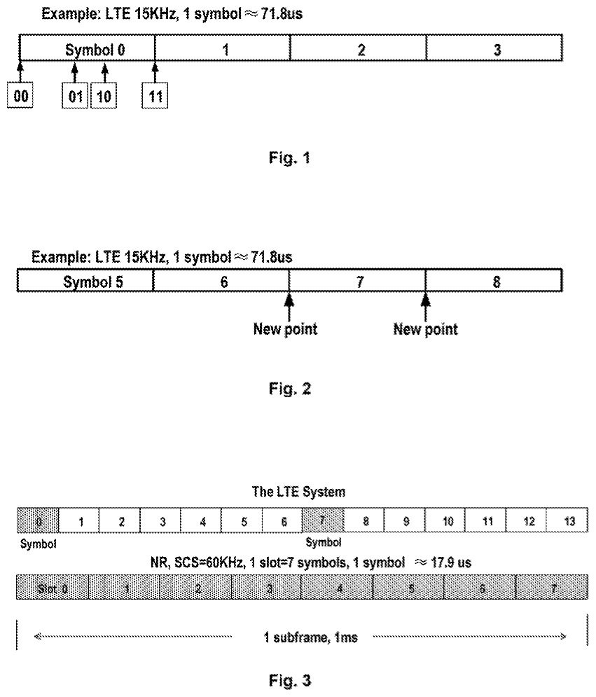

FIG. 2 illustrates newly introduced start points in the LTE system wherein new start points are illustrated by arrows. From FIG. 2 it can be clear that the UL data transmission may start from the start boundary of symbol 7 and also possibly from the start boundary of symbol 8.

Thus, in the LTE system, UE can start uplink data transmission only at specific start position and so does for the downlink data transmission. However, the NR symbol length is much smaller than the LTE symbol length, and thus UE in the NR system can start data transmission in each slot of a subframe

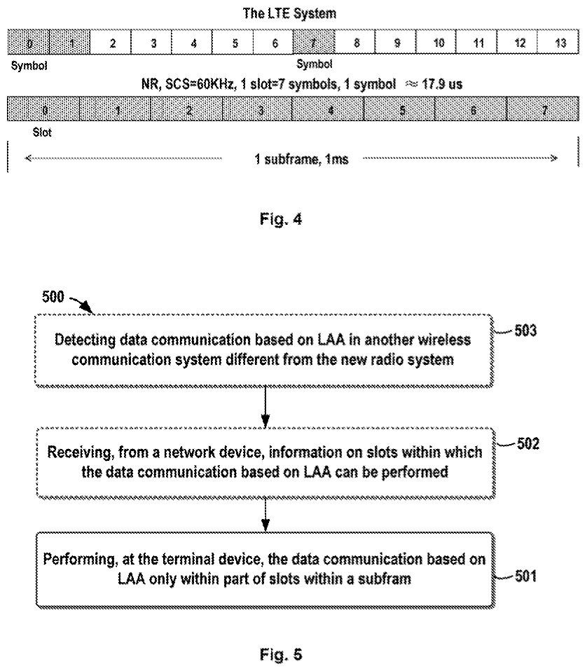

For illustrative purposes, FIGS. 3 and 4 schematically illustrate transmission opportunities of NR-based LAA and LTE-based LAA in DL data transmission and UL data transmission, respectively. From FIGS. 3 and 4, it can be seen that the UE in the LTE system can only start the downlink data transmission based on LAA from symbols 0 and 7, while for the uplink data transmission the UE in the LTE system can start uplink data transmission from symbol 0, symbol 1 and 7. On the contrary, the NR symbol length is quite small and a subframe can contain several slots and in each slot, it can start the data transmission based on LAA. This means that the data transmission based on LAA in the NR system might be much more frequent than that in the LTE system.

To this end, in the present disclosure, there is proposed a solution of data communication based on LAA in the NR system to enable a fair sharing of unlicensed channel between the NR system and the LTE system. Hereinafter, reference will be further made to FIGS. 5 to 13 to describe the data communication based on LAA in the NR system. It shall be appreciated that all embodiments are given for illustrative purposes and the present disclosure is not limited thereto.

FIG. 5 schematically illustrates a flow chart of a method of data communication based on LAA at a terminal device in a NR system according to an embodiment of the present disclosure. The method 500 can be performed at a terminal device, for example UE, or other like terminal devices.

As illustrated in FIG. 5, first in step 501, the terminal device may perform the data communication based on LAA only within part of slots of a subframe. In other words, in embodiments of the present disclosure, the data communication based on LAA is not performed within each of slots of a subframe but performed only within part of slots of a subframe. In such a way, it is possible to share the unlicensed channel between the LTE UE and the NR UE in a more fair way.

In an embodiment of the present disclosure, the data communication based on LAA is performed within any of one or more slots starting from a start boundary of the subframe; and one or more slots starting from a middle point of the subframe. That is to say, the data transmission based on LAA can start from the start of the subframe or from the middle point of the subframe and last for one or more slots.

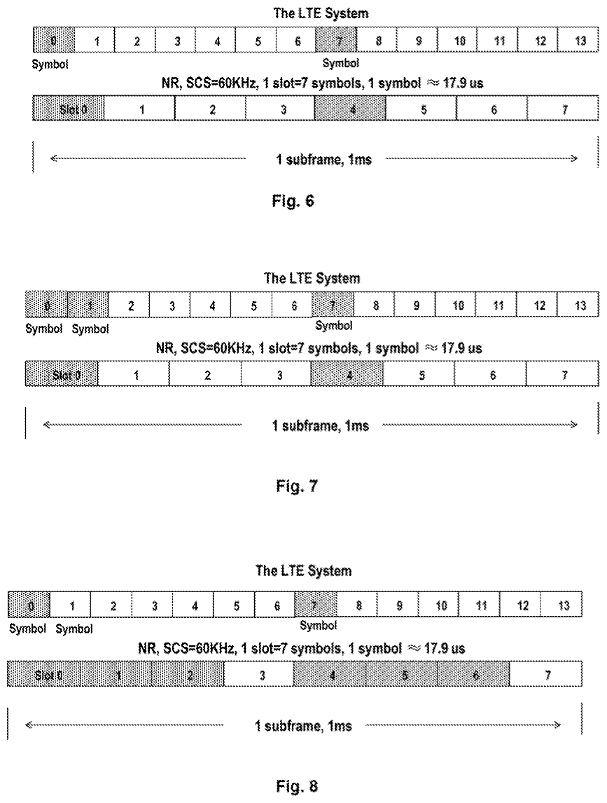

For illustration purposes, FIG. 6 schematically illustrates example transmission opportunities of NR-based LAA and LTE-based LAA in DL data transmission according to an embodiment of the present disclosure. As illustrated in FIG. 6, in the LTE system, the DL data transmission can start from symbol 0 or symbol 7; while in the NR system, the DL data transmission can start from the start or half of the subframe. As is clear from FIG. 6, the UE in the NR system and the UE in the NR system may share the unlicensed band in the DL transmission in a rather fair way.

FIG. 7 further schematically illustrates example transmission opportunities of NR-based LAA and LTE-based LAA in UL data transmission according to an embodiment of the present disclosure. As illustrated in FIG. 7, in the LTE system, the UL data transmission can start from symbol 0, symbol 1, or symbol 7, while in the NR system, the UL data transmission can start from the start or half of the subframe. As is clear from FIG. 7, the UE in the LTE system and the UE in the NR system may share the unlicensed band in the UL transmission in a rather fair way.

In another embodiment of the present disclosure, the data communication based on LAA can be performed on predetermined slots within the subframe.

In an embodiment of the present disclosure, the terminal device may, optionally, receive, from a network device, information on one or more slots within which the data communication based on LAA can be performed, as illustrated in step 502 of FIG. 5. The data communication based on LAA is performed within slots indicated by the information

The information may indicate, for example, one or more slots within which the data transmission based on LAA can be performed. Or alternatively, the information may indicate one or more slots which shall be punctured. The slots not for transmission based on LAA or those punctured slots can be used for CCA by the UE in LTE system. Based on such information on slots, the terminal device can learn one or more slots within which the UL or DL data transmission based on LAA can be performed.

For illustration purposes, FIG. 8 schematically illustrates another example transmission opportunities of NR-based LAA and LTE-based LAA in DL data transmission according to an embodiment of the present disclosure. As illustrated in FIG. 8, in the LTE system, the DL data transmission can start from symbol 0 or symbol 7, while in the NR system, the DL data transmission can start from any slots of the subframe but slots immediately before the middle point of the subframe and the end boundary of the subframe, i.e., slot 3 and slot 7. Thus, slot 3 and slot 7 can be used for CCA by the UE in the LTE system. In this way, it may enable the sufficient use of the unlicensed band and meanwhile can also ensure the LTE system to obtain a relatively fair opportunity to use the unlicensed band.

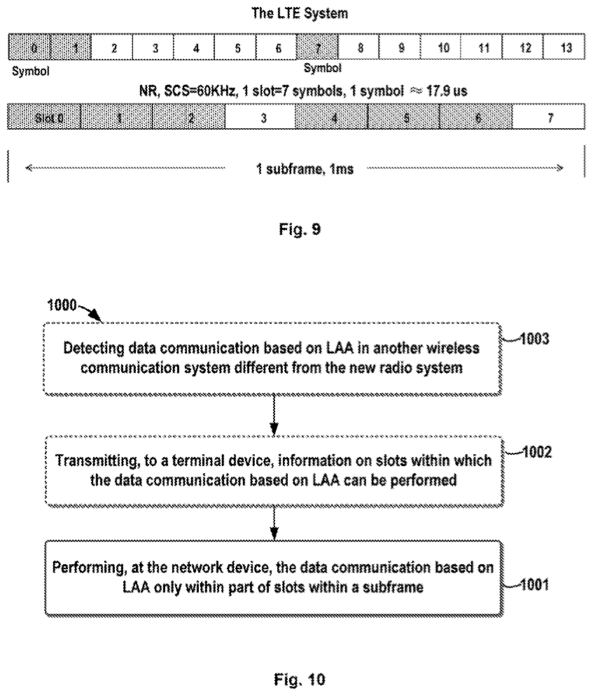

For illustration purposes, FIG. 9 schematically illustrates another example transmission opportunities of NR-based LAA and LTE-based LAA in UL data transmission according to an embodiment of the present disclosure. As illustrated in FIG. 9, in the LTE system, the UL data transmission can start from symbol 0, symbol 1 or symbol 7, while in the NR system, the UL data transmission can start from any slots of the subframe but slots immediately before the middle point of the subframe and the end boundary of the subframe, i.e., slot 3 and slot 7. Thus, similarly to the DL data transmission, slot 3 and slot 7 can be used for CCA by the UE in the LTE system. In this way, it may enable the sufficient use of the unlicensed band and meanwhile can also ensure the LTE system to obtain a relatively fair opportunity to use the unlicensed band.

On the other hand, it shall also be noted that the slots not for transmission based on LAA or those punctured slots can also be predetermined, which are known for both the UE and the gNB. In such a way, it is possible to cancel the requirements for receiving information on one or more slots within which the data communication based on LAA can be performed.

Next, reference can be back made to FIG. 5, optionally in step 503, the terminal device may detect data communication based on LAA in another wireless communication system different from the NR system, and the above-mentioned method can be enabled in response to detection of the data communication based on LAA in the other wireless communication system. The other communication system can be for example the LTE system. In other words, only when it is the case of coexistence of the LTE system and NR system, the UE in the NR system will perform the method as proposed herein. In such a way, it may also ensure the sufficient use of the unlicensed band to improve the performance of the NR system when there is only the NR system.

FIG. 10 schematically illustrates a flow chart of a method for data communication based on LAA at a network device in a NR system according to an embodiment of the present disclosure. The method 1000) can be performed at a network device or network node, for example gNB, or other like network devices.

As illustrated in FIG. 10, first in step 1001, the network device may perform the data communication based on LAA only within part of slots of a subframe. In other words, in embodiments of the present disclosure, the data communication based on LAA, such as UL data transmission or the DL data transmission or both, is not performed within each of slots of a subframe but performed only within part of slots of a subframe. In such a way, it is possible to share the unlicensed channel between the LTE system and the NR system in a more fair way.

In an embodiment of the present disclosure, the data communication based on LAA can be performed within any of one or more slots starting from a start boundary of the subframe; and one or more slots starting from a middle point of the subframe. That is to say, the data transmission based on LAA can start from the start of the subframe or from the middle point of the subframe and last for one or more slots. For detailed examples, reference may be made to those descriptions with reference to FIGS. 6 and 7.

In another embodiment of the present disclosure, the data communication based on LAA can be performed on predetermined slots within the subframe.

In an embodiment of the present disclosure, the network device may, optionally, transmit, to the terminal device, information on one or more slots within which the data communication based on LAA can be performed, as illustrated in step 1002 of FIG. 10. The information may indicate, for example, one or more slots within which the data transmission based on LAA can be performed. Or alternatively, the information may indicate one or more slots which shall be punctured. The slots not for transmission based on LAA or those punctured slots can be used for CCA by the UE in LTE system. Based on such information on slots, the terminal device can learn one or more slots within which the UL or DL data transmission based on LAA can be performed. For detailed examples, reference may be made to those descriptions with reference to FIGS. 8 and 9.

Additionally, it shall also be noted that the slots not for transmission based on LAA or those punctured slots can also be predetermined slots, which are known for both the UE and the gNB. In such a way, it is possible to cancel the requirement for transmitting information on one or more slots within which the data communication based on LAA can be performed.

Optionally in step 1003, the network device may detect data communication based on LAA in another wireless communication system different from the NR system, and the above-mentioned method can be enabled in response to detection of the data communication based on LAA in the other wireless communication system. In other words, only when it is the case of coexistence of the LTE system and NR system, the gNB in the NR system will perform the method as proposed herein. In such a way, it may also ensure the sufficient use of the unlicensed band to improve the performance of the NR system when there is only the NR system.

It shall be appreciated that embodiments of the method of data communication based on LAA at a network device are described in brief hereinbefore and for some details shared by the UL data transmission at the terminal device, one may refer to description with reference to FIGS. 5 to 9.

With embodiments of the present disclosure, it is possible to share the unlicensed channel between the NR-based LAA and LTE-based LAA in a fair way and thus it may provide a good coexistence between the NR-based LAA and LTE-based LAA.

FIG. 11 schematically illustrates a block diagram of an apparatus for uplink data transmission according to an embodiment of the present disclosure. Apparatus 1100 can be implemented at a terminal device such as the UE, or any other terminal devices.

As illustrated in FIG. 11, apparatus 1100 may include a data communication module 1101. The data communication module 1101 may be configured to perform, at the terminal device, the data communication based on LAA only within part of slots of a subframe.

In an embodiment of the present disclosure, the data communication based on LAA may be performed within any of one or more slots starting from a start boundary of the subframe; and one or more slots starting from a middle point of the subframe.

In another embodiment of the present disclosure, the data communication based on LAA may be performed on predetermined slots within the subframe.

In a further embodiment of the present disclosure, the data communication based on LAA may comprise at least one of uplink data transmission and downlink data receiving. Apparatus 1100 may further comprise an information receiving module 1102, which may be configured to receive, from a network device, information on one or more slots within which the data communication based on LAA can be performed. In such a case, the data communication module 1101 may be further configured to perform the data communication based on LAA within slots indicated by the information.

In an embodiment of the present disclosure, the information may indicate at least one of: one or more slots within which the data transmission based on LAA can be performed; and one or more slots which shall be punctured.

In a still further embodiment of the present disclosure, apparatus 1100 may further comprise a communication detection module, which may be configured to detect data communication based on LAA in another wireless communication system different from the NR system. In such a case, the data transmission module 1101 and optionally the information receiving module 1102 may be enabled in response to detection of the data communication based on LAA in the other wireless communication system.

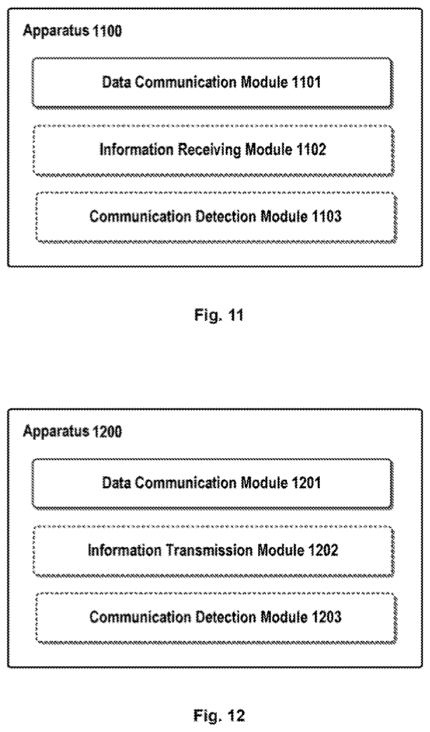

FIG. 12 schematically illustrates a block diagram of an apparatus for data communication based on LAA at a network device in a NR system according to an embodiment of the present disclosure. Apparatus 1200 may be implemented at a network device such as gNB, or other like network devices.

As illustrated in FIG. 12, apparatus 1200 may comprise a data communication module 12011, which may be configured to perform, at the network device, the data communication based on LAA only within part of slots of a subframe.

In an embodiment of the present disclosure, the data communication based on LAA may be performed within any of one or more slots starting from a start boundary of a subframe; and one or more slots starting from a middle point of the subframe.

In another embodiment of the present disclosure, the data communication based on LAA may be performed on predetermined slots of a subframe.

In a further embodiment of the present disclosure, the data communication based on LAA may comprise at least one of downlink data transmission and uplink data receiving. Apparatus 1200 may further comprise an information transmission module 1202, which may be configured to transmit, to a terminal device, information on one or more slots within which the data communication based on LAA can be performed.

In a still further embodiment of the present disclosure, the information may indicate at least one of one or more slots within which the data transmission based on LAA can be performed; and one or more slots which shall be punctured.

In a yet further embodiment of the present disclosure, apparatus 1200 may further comprise a communication detection module 1203, which may be configured to detect data communication based on LAA in another wireless communication system different from the NR system. In such a case, the data transmission module 1201 and optionally the information transmission module 1202 may be enabled in response to detection of the data communication based on LAA in the other wireless communication system.

Hereinbefore, apparatuses 1100 and 1200 are described with reference to FIGS. 11 and 12 in brief. It can be noted that the apparatuses 1100 and 1200 may be configured to implement functionalities as described with reference to FIGS. 5 to 10. Therefore, for details about the operations of modules in these apparatuses, one may refer to those descriptions made with respect to the respective steps of the methods with reference to FIGS. 5 to 10.

It is further noted that components of the apparatuses 1100 and 1200 may be embodied in hardware, software, firmware, and/or any combination thereof. For example, the components of apparatuses 1100 and 1200 may be respectively implemented by a circuit, a processor or any other appropriate selection device.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, apparatuses 1100 and 1200 may comprise at least one processor. The at least one processor suitable for use with embodiments of the present disclosure may include, by way of example, both general and special purpose processors already known or developed in the future. Apparatuses 1100 and 1200 may further comprise at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause apparatuses 1100 and 1200 to at least perform operations according to the method as discussed with reference to FIGS. 5 to 10 respectively.

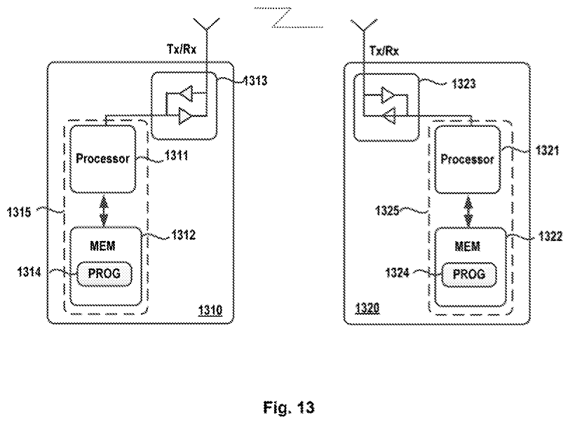

FIG. 13 further illustrates a simplified block diagram of an apparatus 1310 that may be embodied as or comprised in a network device like a base station in a wireless network and an apparatus 1320 that may be embodied as or comprised in a terminal device like UE as described herein.

The apparatus 1310 comprises at least one processor 1311, such as a data processor (DP) and at least one memory (MEM) 1312 coupled to the processor 1311. The apparatus 1310 may further comprise a transmitter TX and receiver RX 1313 coupled to the processor 1311, which may be operable to communicatively connect to the apparatus 1320. The MEM 1312 stores a program (PROG) 1314. The PROG 1314 may include instructions that, when executed on the associated processor 1311, enable the apparatus 1310 to operate in accordance with embodiments of the present disclosure, for example the method 1000. A combination of the at least one processor 1311 and the at least one MEM 1312 may form processing means 1315 adapted to implement various embodiments of the present disclosure.

The apparatus 1320 comprises at least one processor 1321, such as a DP, and at least one MEM 1322 coupled to the processor 1321. The apparatus 1320 may further comprise a suitable TX/RX 1323 coupled to the processor 1321, which may be operable for wireless communication with the apparatus 1310. The MEM 1322 stores a PROG 1324. The PROG 1324 may include instructions that, when executed on the associated processor 1321, enable the apparatus 1320 to operate in accordance with the embodiments of the present disclosure, for example to perform the method 500. A combination of the at least one processor 1321 and the at least one MEM 1322 may form processing means 1325 adapted to implement various embodiments of the present disclosure.

Various embodiments of the present disclosure may be implemented by computer program executable by one or more of the processors 1311, 1321, software, firmware, hardware or in a combination thereof.

The MEMs 1312 and 1322 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 1311 and 1321 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the an readily understand. Such modifications and variations are considered to be within the scope of the disclosure and the appended claims. The protection scope of the disclosure is defined by the accompanying claims.

1.-26. (canceled)

27. A method performed by a terminal device in a new radio system, comprising:
receiving, from a network device, information, and
performing, to the network device, a first uplink transmission in first one or more consecutive slots indicated by the information.

28. The method of claim 27, wherein the information indicates the first one or more consecutive slots within which the first uplink transmission of the terminal device to be performed.

29. The method of claim 27, wherein the information indicates more than two consecutive slots in a subcarrier spacing.

30. The method of claim 27 further comprising:
performing, to the network device, a second uplink transmission in second one or more consecutive slots after predetermined slots or symbols from the first uplink transmission.

31. The method of claim 30, wherein the predetermined slots or symbols is indicated by the information.

32. The method of claim 31, wherein the information further indicates there is no transmission in the predetermined slots or symbols.

33. The method of claim 27, wherein the first uplink transmission is performed in an unlicensed resource.

34. A method performed by a network device in a new radio system, comprising:
transmitting, to a terminal device, information, and
receiving, from the terminal device, a first uplink transmission in first one or more consecutive slots indicated by the information.

35. The method of claim 34, wherein the information indicates the first one or more consecutive slots within which the first uplink transmission of the terminal device to be performed.

36. The method of claim 34, wherein the information further indicates more than two consecutive slots in a subcarrier spacing.

37. The method of claim 34 further comprising:
receiving, from the terminal device, a second uplink transmission in second one or more consecutive slots after predetermined slots or symbols from a reception of the first uplink transmission.

38. The method of claim 37, wherein the predetermined slots or symbols is indicated by the information.

39. The method of claim 38, wherein the information further indicates there is no transmission in the predetermined slots or symbols.

40. The method of claim 34, wherein the first uplink transmission is performed in an unlicensed resource.

41. A terminal device in a new radio system comprising a processor configured to:
receive, from a network device, information, and
perform, to the network device, a first uplink transmission in first one or more consecutive slots indicated by the information.

42. The terminal device of claim 41, wherein the processor further configured to:
perform, to the network device, a second uplink transmission in second one or more consecutive slots after predetermined slots or symbols from the first uplink transmission.

43. The terminal device of claim 42, wherein the predetermined slots or symbols is indicated by the information.

44. The terminal device of claim 43, wherein the information further indicates there is no transmission in the predetermined slots or symbols.
